(19) United States
(12) Patent Application Publication
(10) Pub. No.: US 2004/0050667 A1
(43) Pub. Date: Mar. 18, 2004

(54) Oven and proofing chain

(76) Inventors: Marie K. Wiese, Mukwonago, WI (US); John W. Spano, Brookfield, WI (US)

Correspondence Address: QUARLES & BRADY LLP, 411 E. WISCONSIN AVENUE, SUITE 2040, MILWAUKEE, WI, 53202-4497, US

(21) Appl. No.: 10/620,195

(22) Filed: Jul. 15, 2003

Related U.S. Application Data
(60) Provisional application No. 60/396,601, filed on Jul. 18, 2002.

(51) Int. Cl. B65G 45/14

(52) U.S. Cl. 198/498

(57) ABSTRACT

A conveyor chain link includes a block link and at least one longitudinal plate. The plate has one end pivotally fixed to the block link and a second end pivotally linkable to a block link of an adjacent conveyor chain link. At least one vertical roller is detachably fixed to the block link for supporting the link in a track. In one embodiment, the chain link includes a sweeper extending from the at least one plate, wherein the sweeper urges debris along the track as the link passes through the track.

### CROSS REFERENCES TO RELATED APPLICATIONS

This application claims the priority benefit of U.S. Provisional Patent Application No. 60/396,601 filed on Jul. 18, 2002.

### STATEMENT REGARDING FEDERALLY SPONSORED RESEARCH

Not Applicable.

### BACKGROUND OF THE INVENTION

Oven and proofing chains are used to convey dough through a proofing apparatus which causes the dough to rise and/or through an oven which bakes the dough. A typical proofing or oven chain comprises a plurality of links forming a continuous chain which is pulled through a substantially closed guide track. Each link includes a pair of plates connected to block links. A horizontal roller interposed between the plates engage side walls of the track to guide the link inside the track. Vertical rollers rotatably mounted to the block links support the chain in the track. The vertical rollers are permanently fixed to the block link using rivets and the like.

The environment in both the proofing apparatus and oven can cause the rollers to fail. When a vertical roller fails it must be replaced which requires disassembling the chain, and replacing the entire block link on which the failed roller is permanently affixed. The replaced block link is then discarded along with the rollers attached thereto. This is extremely time consuming and wasteful since the block link is typically undamaged, and if two rollers are fixed to the block link, the roller that has not failed is also discarded.

The vertical track through which the chain is pulled includes a longitudinal slot formed in the track top. Debris falls into the track through the slot, and collects in the track until the chain is shut down for cleaning. Shutting down the conveyor system to clean out the track and prevent damage to the chain is expensive.

### SUMMARY OF THE INVENTION

The present invention provides a conveyor chain link including a block link and at least one longitudinal plate. The plate has one end pivotally fixed to the block link and a second end pivotally linkable to a block link of an adjacent conveyor chain link. At least one vertical roller is detachably fixed to the block link for supporting the link in a track. In one embodiment, the chain link includes a sweeper extending from the at least one plate, wherein the sweeper urges debris along the track as the link passes through the track.

A general objective of the present invention to reduce the downtime required to replace a failed vertical roller. This objective is accomplished by providing a conveyor chain link for the conveyor chain which has easily replaceable vertical rollers.

Another objective of the present invention is to reduce the downtime necessary to clean the track of a conveyor system. This objective is accomplished by providing a sweeper on a conveyor chain link which sweeps debris from the track to reduce the time necessary for cleaning the track.

These and still other objectives and advantages of the present invention will be apparent from the description which follows. In the detailed description below, preferred embodiments of the invention will be described in reference to the accompanying drawings. These embodiments do not represent the full scope of the invention. Rather the invention may be employed in other embodiments. Reference should therefore be made to the claims herein for interpreting the breadth of the invention.

### BRIEF DESCRIPTION OF THE DRAWINGS

FIG. 1 is a top view of conveyor chain incorporating the present invention;

FIG. 2 is a side view of the conveyor chain of FIG. 1;

FIG. 3 is an end view of the conveyor chain of FIG. 1;

FIG. 4 is a cross sectional view of a vertical roller of FIG. 1;

FIG. 5 is an axial view of the vertical roller of FIG. 4;

FIG. 6 is a perspective view of the conveyor chain of FIG. 1; and

FIG. 7 is an alternative vertical roller incorporating the present invention.

### DETAILED DESCRIPTION OF THE INVENTION

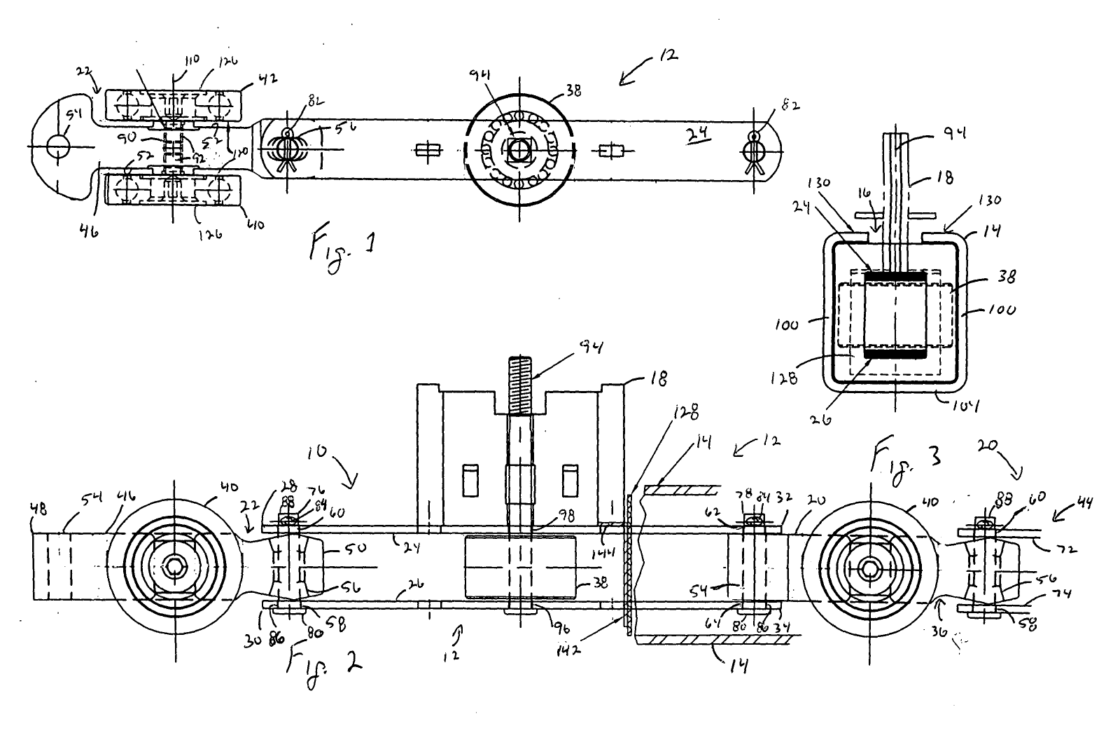

As shown in FIGS. 1-3, a conveyor system for conveying products through a proofer and/or oven includes a conveyor chain 10 formed from a plurality of substantially identical links 12. Each link 12 of the conveyor chain 10 is pivotally fixed to an adjacent link 20 to form an endless chain 10. The chain 10 passes through an elongated guide track 14 having an elongated slot 16. Product supports 18 fixed to each link 12 supports the product above the guide track 14 as the chain 10 conveys the product through an oven, proofer, and the like.

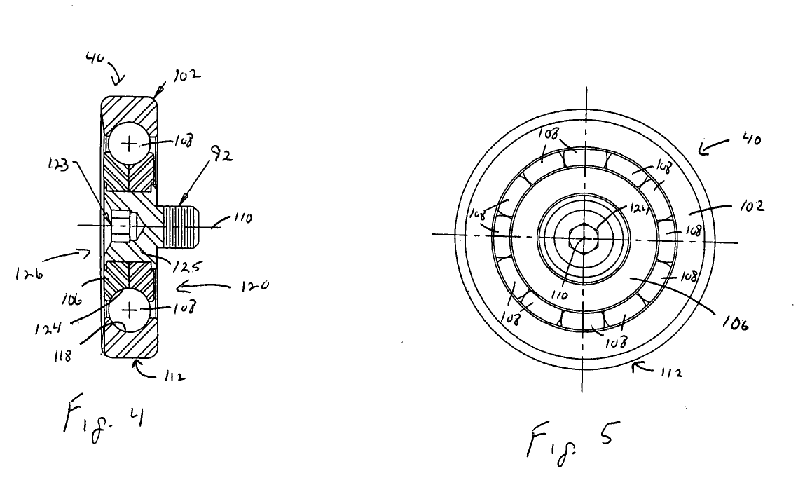

Referring to FIGS. 3 and 6, the guide track 14 defines the path of the product conveyed by the chain 10, and includes vertically extending sides 100 joined by a substantially planar bottom 104. Two top pieces 130 extending inwardly toward each other from a top edge of each opposing side 100 define the elongated slot 16. The chain links 12, 20 forming the chain 10 pass through the space defined by the top pieces 130, sides 100, and bottom 104 which guide the chain 10 along the path.

Referring now to FIGS. 1-3, in a preferred embodiment, each link 12 forming part of the chain 10 includes a block link 22 which is pivotally fixed to a pair of vertically spaced, parallel, longitudinal plates 24, 26. Each plate 24, 26 has one end 28, 30 pivotally fixed to the block link 22 and a second end 32, 34 pivotally fixed to a block link 36 of the adjacent link 20. A horizontal roller 38 is mounted between the two plates 24, 26 to keep the conveyor chain 10 centered within the spaced defined by the track 14. Vertical rollers 40, 42 detachably fixed to the block link 22 engage the track bottom 104 to support the link 12 in the track 14.

The block link 22 includes a body 46 having opposing ends 48, 50 joined by sides 52. A vertical bore 56 formed in one end 50 of the block link body 46 receives a pin 76 for pivotally connecting the plates 24, 26 thereto. A second vertical bore 54 is formed in the opposing end 48 of the block link body 46 for pivotally connecting the plates of the link adjacent the opposing end 48 of the block link body 46.

A transverse horizontal bore 90 formed through the block link body 46 receives a threaded stud 92 (shown best in FIG. 4) extending from each vertical roller 40, 42 to detachably fix each vertical roller 40, 42 to the block link 22. The bore 90 can be threaded to threadably engage the stud 92. Preferably, a locking insert, such as available from Fairchild Fasteners of Dulles, Va., is inserted into each end of the bore 90. The locking insert threadably engages the stud 92, and inhibits inadvertent disengagement of the stud 92 from the insert due to vibrations.

The elongated plates 24, 26 extend between, and link, the two block links 22, 36. Although a pair of plates 24, 26 is disclosed, the link 12 can include one or more plates without departing from the scope of the invention. Each plate 24, 26 is connected to the block link 22 by aligning the vertical bore 56 with one of holes 58, 60 formed in one end 28, 30 of each plate 24, 26. Holes 62, 64 formed in the opposing end 32, 34 of the plates 24, 26 are aligned with the vertical bore 54, formed in the opposing end 48 of the adjacent block link 36.

The pivot pin 76 having a head 80 formed at one end 86 includes an opposing end 88 inserted through the bore 56 and respectively aligned holes 58, 60. The pivot pin 76 pivotally links the plates 24, 26 to the block link 22, and is retained in the bore 56 by a cotter pin 82. The cotter pin 82 is inserted through a hole 84 in the opposing pin end 88 to prevents the pivot pin 76 from slipping out of the bore 56. A second pivot pin 78 substantially identical to the first pin 76 is inserted through the bore 54 of the adjacent block link 36 and the holes 62, 64 to pivotally connect the opposing ends 32, 34 of the plates 24, 26 to the adjacent link block link 36. The plates 72, 74 of the adjacent link 20 are then pivotally connected to the adjacent block link 36, in the same manner as described for the one end of the plates 24, 26 connected to the block link 22.

The horizontal roller 38 is mounted between the plates 24, 26, and freely rotates about a vertical shaft 94. The vertical shaft 94 extends through holes 96, 98 formed in the plates 24, 26, and intermittently engages the sides 100 of the track 14 as the link moves through the track 14. The roller 38 has a diameter which is greater than the width of the plates 24, 26, such that the roller 38 extends transversely past the plates 24, 26. Although a single horizontal roller 38 interposed between the pair of plates 24, 26 is disclosed, more than one roller interposed between the pair of plates can be provided without departing from the scope of the invention.

The substantially identical vertical rollers 40, 42 are detachably fixed to the block link 22, and support the weight of the conveyor chain 10 and product being conveyed. Although a pair of vertical rollers is disclosed, a single vertical roller fixed to the block link can be used without departing from the scope of the invention. Advantageously, the vertical rollers 40, 42 are detachably fixed to the block link 22 to allow replacement of the vertical rollers 40, 42 without disassembling the block link 22 from the plates 24, 26. Moreover, when one vertical roller fails, only the failed roller need be replaced.

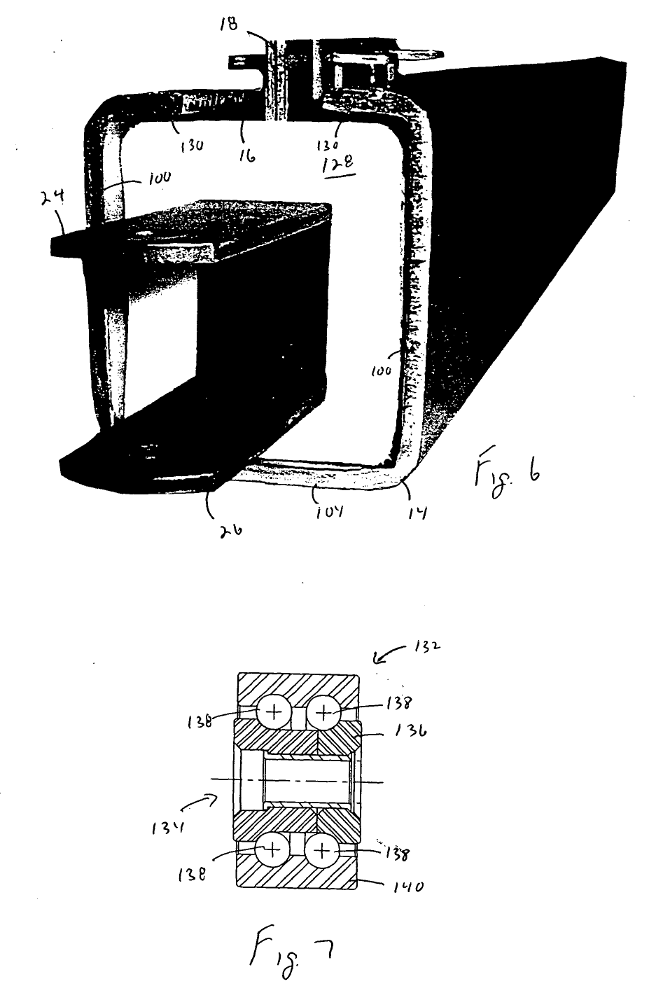

The vertical rollers 40, 42 are substantially identical. Therefore, only one vertical roller 40 will be described with the understanding that the description also applies to the other vertical roller 42. Referring to FIGS. 4 and 5, the vertical roller 40 include an outer race 102 which engages a track bottom 104 and an inner race 106. Ball bearings 108 interposed between the inner and outer races 106, 102 allow the outer race 102 to revolve about a roller axis 110 while the inner race 106 is fixed relative to the block link 22. The size and number of ball bearings 108 is dependent on the desired size of the roller and load capacity of the chain link.

The outer race 102 includes a radially outwardly facing surface 112 which engages the track bottom 104. The radially outwardly facing surface 112 is joined to a radially inwardly facing surface 114 by sidewalls 116. A radially inwardly opening groove 118 is formed in the radially inwardly facing surface 114 of the outer race 102. The inner race 106 is disc shaped having opposed axially facing sides 120, 122. A radially outwardly facing circumferential groove 124 formed in the inner race 106 between the inner race sides 120, 122 opens radially outwardly toward the inwardly opening groove 118 formed in the outer race 102. The grooves 118, 124 cooperatively capture the ball bearings 108 therebetween.

The axially extending stud 92 extends from one side 120 of the inner race 106 coaxial with the roller axis 110. The one side 120 faces inwardly toward the block link 22. Preferably, the stud 92 includes external threads to threadably engage the locking insert, or internal threads, in the bore 90 to detachably fix the vertical roller 40 to the block link 22. Advantageously, detachably fixing the vertical roller 40 to the block link 22 allows detaching the roller 40 from the block link 22 if the roller 40 requires replacement. The stud 92 can be formed as an integral part of the inner race 106 or fixed to the inner race 106 using methods known in the art, such as welding, crimping, threadably engaging, and the like, without departing from the scope of the invention. Moreover, although threadably engaging the stud with the block link to detachably fix the roller to block link is preferred, other methods for detachably fixing the roller to the block link, such as described below and shown in FIG. 7, pinning the stud to the block, and the like, can be used without departing from the scope of the invention.

A recessed hex socket 123 fixed relative to the stud 92 extends through the other, or outwardly facing, side 126 of the inner race 106. The socket 123 is coaxial with the roller axis 110, and is engageable by a socket wrench for rotating the stud 92 to threadably engage the stud 92 with the block link 22 and fix the roller 40 to the block link 22. Although a hex socket is preferred, any engagement structure, such as a slot, Phillips head, and the like, which can be engaged to rotate the stud in the link lock bore can be used without departing from the scope of the invention. Preferably, the engagement structure is recessed to prevent dirt from accumulating on surfaces of the outwardly facing inner race side. Most preferably, the engagement structure is formed in a body 125 including the stud 92, as shown in FIG. 4.

The product support 18 is supported above the link 10 by the link upper plate 24, and is fixed to the link 12 by the horizontal roller vertical shaft 94. Preferably, an upper end of the shaft 94 includes threads for threadably engaging a nut which secures the product support 18 to the link 12. A grid or other platform (not shown) can be secured to the product support 18 to provide a large surface for carrying the product.

A sweeper 128 mounted to the link 12 extends radially from the plates 24, 26 to engage debris, such as seeds and flour, and other material in the space defined by the track 14. In the embodiment disclosed herein, the sweeper 128 loosely surrounds the pair of plates 24, 26 and conforms to the inside shape of the track 14 to sweep debris through the track 14. Although, the sweeper 128 disclosed herein is allowed to slide along the plates 24, 26, the sweeper 128 can be fixed relative to the link 12 using methods known in the art, such as a bracket, fasteners, adhesives, and the like without departing from the present invention. In addition, the sweeper 128, can be shaped to sweep only the track bottom 104 or sides 100 without departing from the scope of the invention.

The sweeper 128 can be formed from any suitable material which depends on the intended use of the chain link 12. For example, if the link 12 is used in a proofer, a plastic material, such as an ultra high molecular weight (UHMW) plastic can be used. However, if the chain 10 will be exposed to high heat, such as in an oven, a sweeper formed from a metal, such as stainless steel, or other material having a high melting point, is preferred.

A stop plate 142 can be provided which abuts the sweeper 128. The stop plate is substantially vertical, and squares the sweeper relative to the track to maintain the sweeper in a substantially vertical position. The stop plate 142 includes a tab 144 which is sandwiched between the product support 18 and top plate 24 to clamp the stop plate 142 to the link 12. Although a stop plate is disclosed, a stop plate is not necessary for practicing the invention.

As shown in FIGS. 3 and 6, the track 14 includes the bottom 104, the two sides 100, and two top pieces 130 which define the inside shape of the track. The horizontal roller vertical shaft 94 and product support 18 extend upwardly through the longitudinal slot 16 defined between the two top pieces 130. The horizontal roller 38 engages the track sides 100 to guide the link 12 through the track 14, and the vertical rollers 40, 42 engage the track bottom 104 to support the link 12 in the track 14. Although the track inside shape is defined as being substantially square, the track 14 can have any inside shape without departing from the scope of the invention.

In an alternative embodiment shown in FIG. 7, a vertical roller 132 includes a countersunk bore 134 formed through an inner race 136. A bolt (not shown) having a threaded portion extends through the bore 134, and threadably engages the block link 22, extends completely through the bore 134 to threadably engage a nut, extends completely through the bore 134 to receive a pin, and the like, to detachably fix the roller 132 to the block link 22. As shown in FIG. 7, more than one row of ball bearings 138 can be provided between the inner and outer races 136, 140 to reduce the roller diameter while increasing the load bearing capacity of the roller 132.

While there has been shown and described what are at present considered the preferred embodiments of the invention, it will be obvious to those skilled in the art that various changes and modifications can be made therein without departing from the scope of the invention defined by the appended claims. For example, although the pair of plates 24, 26 of the link 12 are shown as being disposed inside the track 14, one of the plates 24 can be positioned above the longitudinal slot 16, as is known in the art. Of course, if one of the plates 24, 26 is disposed above the track 14, the sweeper 128 does not necessarily surround both plates 24, 26, but would only be mounted relative to the plate 26 disposed within the track 14.

We claim:

1. A conveyor chain link for forming an oven and proofing chain which can be pulled through a substantially closed guide track, said link comprising:
a block link;
at least one longitudinal plate, said plate having one end pivotally fixed to said block link and a second end pivotally linkable to a block link of an adjacent conveyor chain link;
at least one horizontal roller fixed to said at least one longitudinal plate for guiding said link in the track; and
at least one vertical roller detachably fixed to said block link for supporting said link in the track.

2. The conveyor chain link as in claim 1, in which said vertical roller includes a stud extending from one side of said roller coaxial with an axis of rotation of said roller, and said stud is received in a bore formed in said block link to detachably fix said roller to said block link.

3. The conveyor chain link as in claim 1, including a sweeper extending from said at least one plate, wherein said sweeper urges debris along the track as said link passes through the track.

4. The conveyor chain link as in claim 3, in which said sweeper s formed from a material selected from a group consisting of plastic and metal.

5. The conveyor chain link as in claim 3, in which said sweeper is slidable relative to at least a portion of said at least one longitudinal plate.

6. The conveyor chain link as in claim 3, in which a stop plate fixed relative to said at least one longitudinal plate is engageable with said sweeper to square said sweeper relative to the track.

7. The conveyor chain link as in claim 1, including a second longitudinal plate extending substantially parallel to said at least one longitudinal plate, and said at least one horizontal roller is interposed between said second longitudinal plate and said at least one longitudinal plate.

8. The conveyor chain link as in claim 1, including a second vertical roller detachably fixed to said block link, which said block link includes opposing sides, and said at least one vertical roller is detachably fixed to one of said sides and said second vertical roller is detachably fixed to another of said sides.

9. A conveyor chain link for forming an oven and proofing chain which can be pulled through a substantially closed guide track, said link comprising:
a block link;
a least one longitudinal plate, said plate having one end pivotally fixed to said block link and a second end pivotally linkable to a block link of an adjacent conveyor chain link;
at least one vertical roller fixed to said block link for supporting said link in the track; and
a sweeper fixed relative to said at least one longitudinal plate for engaging debris in a track as the link passes through the track.

10. The conveyor chain link as in claim 9, in which said vertical roller is detachably fixed to said block link.

11. The conveyor chain link as in claim 10, in which said vertical roller includes a stud extending from one side of said roller coaxial with an axis of rotation of said roller, and said stud is received in a bore formed in said block link to detachably fix said roller to said block link.

12. The conveyor chain link as in claim 10, including a second vertical roller detachably fixed to said block link, wherein said block link includes opposing sides, and said at least one vertical roller is fixed to one of said sides and said second vertical roller is detachably fixed to another of said sides.

13. The conveyor chain link as in claim 9, in which said sweeper s formed from a material selected from a group consisting of plastic and metal.

14. The conveyor chain link as in claim 9, in which said sweeper is sweeper is slidable relative to at least a portion of said at least one longitudinal plate.

15. The conveyor chain link as in claim 9, in which a stop plate fixed relative to said at least one longitudinal plate is engageable with said sweeper to square said sweeper relative to the track.

16. The conveyor chain link as in claim 9, in which at least one horizontal roller is fixed to said at least one longitudinal plate for guiding said link in a track.

17. The conveyor chain link as in claim 16, including a second longitudinal plate extending substantially parallel to said at least one longitudinal plate, and said at least one horizontal roller is interposed between said second longitudinal plate and said at least one longitudinal plate.

18. A conveyor chain link for forming an oven and proofing chain which can be pulled through a substantially closed guide track, said link comprising:
a block link;
a least one longitudinal plate, said plate having one end pivotally fixed to said block link and a second end pivotally linkable to a block link of an adjacent conveyor chain link;
at least one horizontal roller fixed to said at least one longitudinal plate for guiding said link in the track;
at least one vertical roller detachably fixed to said block link for supporting said link in the track, wherein said vertical roller includes a stud extending from one side of said roller coaxial with an axis of rotation of said roller, and said stud is received in a bore formed in said block link to detachably fix said roller to said block link; and
a sweeper fixed relative to said at least one longitudinal plate for engaging debris in a track as the link passes through the track.

19. The conveyor chain link as in claim 18, including a second vertical roller detachably fixed to said block link, wherein said block link includes opposing sides, and said at least one vertical roller is fixed to one of said sides and said second vertical roller is detachably fixed to another of said sides.

20. The conveyor chain link as in claim 18, in which said sweeper s formed from a material selected from a group consisting of plastic and metal.

21. The conveyor chain link as in claim 19, including a second longitudinal plate extending substantially parallel to said at least one longitudinal plate, and said at least one horizontal roller is interposed between said second longitudinal plate and said at least one longitudinal plate.

22. he conveyor chain link as in claim 19, in which said sweeper is sweeper is slidable relative to at least a portion of said at least one longitudinal plate.

23. The conveyor chain link as in claim 19, in which a stop plate fixed relative to said at least one longitudinal plate is engageable with said sweeper to square said sweeper relative to the track.
